(19) United States
(12) Patent Application Publication
(10) Pub. No.: US 2021/0317696 A1
(43) Pub. Date: Oct. 14, 2021

(54) Solar Powered Door Opener

(71) Applicant: Hall Labs LLC, Provo, UT (US)

(72) Inventors: David R. Hall, Provo, UT (US); Jerome Miles, Spanish Fork, UT (US)

(73) Assignee: Hall Labs LLC, Provo, UT (US)

(21) Appl. No.: 17/355,109

(22) Filed: Jun. 22, 2021

Related U.S. Application Data
(60) Provisional application No. 62/042,522, filed on Aug. 27, 2014.

(51) Int. Cl. E05F 15/668; E05F 15/79

(52) U.S. Cl. CPC E05F 15/668; E05F 15/79; E05Y 2400/614; E05Y 2400/628; E05Y 2900/106

(57) ABSTRACT

The solar powered door system includes a motor configured to raise and lower the door. A cycle is one raise and one lower of the door. The system also includes a battery configured to provide power to the motor. A solar unit is included that is configured to convert solar energy into electrical power to charge the battery. In the system, the motor depletes the battery during operation at an operation rate and the solar unit charges the battery at a replenishment rate. This replenish rate is less than one third of the operation rate. The replenishment rate is also sufficient to keep the battery charged at a level sufficient to power the motor for at least 12 cycles, and preferably at least 25 cycles, in a 24-hour period.

### CROSS-REFERENCE TO RELATED APPLICATIONS

This application claims priority to U.S. Provisional Patent Application No. 62/042,522 entitled “SOLAR POWERED OVERHEAD DOOR” filed on Jun. 22, 2020, which is incorporated by reference in its entirety.

### TECHNICAL FIELD

The present disclosure is directed to a system for powering a door opener.

### BACKGROUND

Door openers, such as those that operate overhead doors, like garage doors, come in many different shapes and sizes and conventionally rely on a constant connection to a power source such as an outlet. Some openers have a battery that is used for backup. However, such batteries are not intended to provide power to the opener over a sustained period of time. There is a need for an improved door opener, battery, and power supply.

### SUMMARY

Embodiments of the present disclosure are directed to a system for operating a door opener. The system includes a motor configured to raise and lower the door. A cycle is one raise and one lower of the door. The system also includes a battery configured to provide power to the motor. A solar unit is included that is configured to convert solar energy into electrical power to charge the battery. In the system, the motor depletes the battery during operation at an operation rate and the solar unit charges the battery at a replenishment rate. This replenish rate is less than one third of the operation rate. The replenishment rate is also sufficient to keep the battery charged at a level sufficient to power the motor for at least 12 cycles, and preferably at least 25 cycles, in a 24-hour period.

Further embodiments of the present disclosure are directed to a power system for a door including a battery powering the door, a solar unit configured to charge the battery, and a processor and memory configured to execute computer readable instructions that, when executed by the processor cause the power system to perform acts. The acts include monitoring an operation depletion rate of the battery during operation of the door, monitoring an operation time of the door corresponding to the operation depletion rate, and monitoring a replenishment rate of the battery from the solar unit. If a multiple of the operation depletion rate and the operation time are greater than a predetermined threshold, the power system increases the replenishment rate.

Still further embodiments of the present disclosure are directed to a door which includes a motor to operate the door to raise, lower, and stop movement of the door. The door also includes a battery powering the motor and a solar unit having a capacity to charge the battery at a replenishment rate. The battery has an operation depletion rate correlated to operation of the motor through cycles, wherein one cycle comprises one raise of the door and one lower of the door. The capacity of the solar unit is sufficient to maintain the battery at an average stable level unless the motor executes more than 12 cycles in a 24-hour period. Also, the operation depletion rate is at least three times greater than the replenishment rate.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a schematic illustration of a system for providing solar power to an overhead door opener according to embodiments of the present disclosure.

FIG. 2 is a schematic illustration of a system for using a solar unit to power an overhead door operator according to embodiments of the present disclosure.

FIG. 3 is a graph showing battery level over time according to embodiments of the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

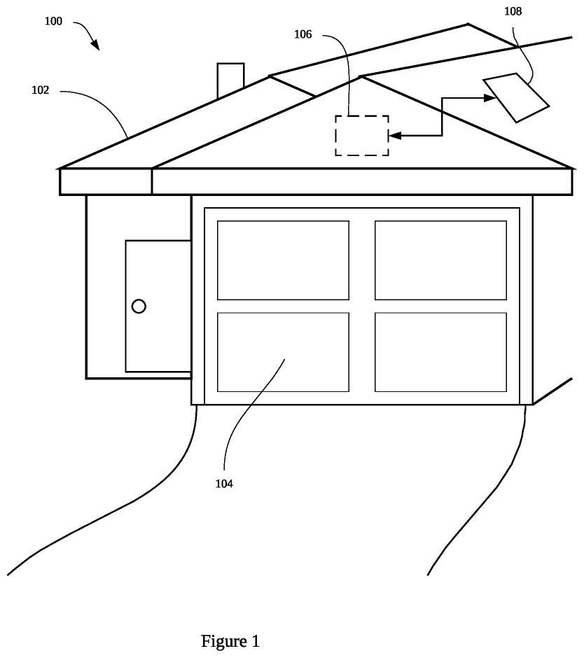

FIG. 1 is a schematic illustration of a system 100 for providing solar power to an automated door opener according to embodiments of the present disclosure. In this case, the door is an overhead door, such as a typical garage door. In other embodiments, the automated door can be of another type, such as a typical hinged or sliding door on a building such as a residence or a barn.

The system 100 is deployed for use with a house 102, but can also be used for a residential, commercial, industrial structure, or any other type of structure. The house 102 has an overhead door 104 which can be a sectional door, a rolling door, or any other type of overhead door that is used to provide access to a garage of the house 102. The overhead door 104 is raised and lowered by an opener 106 that is inside the garage. The opener 106 can raise, lower, and stop movement of the overhead door as is known in the art. There are many types of overhead door openers that can operate with the system 100 of the present disclosure.

Power to the opener 106 is provided by a solar panel 108. The solar panel 108 can be positioned on a roof as shown in FIG. 1, or it can be nearby on the ground or on another structure. In some embodiments, the solar panel is placed in the window of the structure, so that it can receive adequate sunshine and still be protected from the elements.

The solar panel 108 is configured to convert radiant energy from the sun into electrical power that is used for the overhead door opener 106. In some embodiments the solar panel 108 and the overhead door opener 106 form a closed loop, wherein the solar panel 108 provides power to the overhead door opener 106 and to no other device. The overhead door opener 106 can include lights, sensors, remote communication systems such as wireless communication systems and other components. The solar panel 108 provides the power for these devices as well as the motor of the overhead door opener 106.

The capacity of the solar panel 108 is selected based on the power requirements of the overhead door opener 106. Doors vary in weight, and the distance required to travel the precise capacity may vary. Nevertheless, in some embodiments the solar panel 108 is designed to provide sufficient power to execute at least 12 cycles, and preferably at least 25 cycles of the overhead door opener 106 each day. A cycle is defined as one full raise and one full lower of the overhead door 104. Research has shown that 25 cycles/day covers at least 95% of the uses. Most people use their overhead doors less than three cycles per day, but in some unusual situations the overhead door is used for something out of the ordinary, such as on moving day. Even in these cases 25 cycles per day may be more than enough. Sizing the solar panel accordingly results in a more efficient system than might otherwise result.

The system 100 can be used in remote areas where there are no other power options available. The system 100 can be used in areas that are inconvenient to run power. For example, for housing structures with an outbuilding, such as a stable, barn or tool shed, having an automated door that may be 100 yards or so away from the main structure. The system 100 avoids the expense and hassle of running electrical line all the way from the main structure to the overhead door 104.

In addition, the system 100 may be advantageous to use in settings where there just is not a convenient source of power, i.e. power outlet, in the garage or the like where the opener is to be used. This can be a particular issue for the DIY installer, in view of the many code regulations. Thus, the solar option provided by system 100 may solve a problem for a DIY installer, who does not want to hire an electrician to put in a new power outlet to service a new door opener.

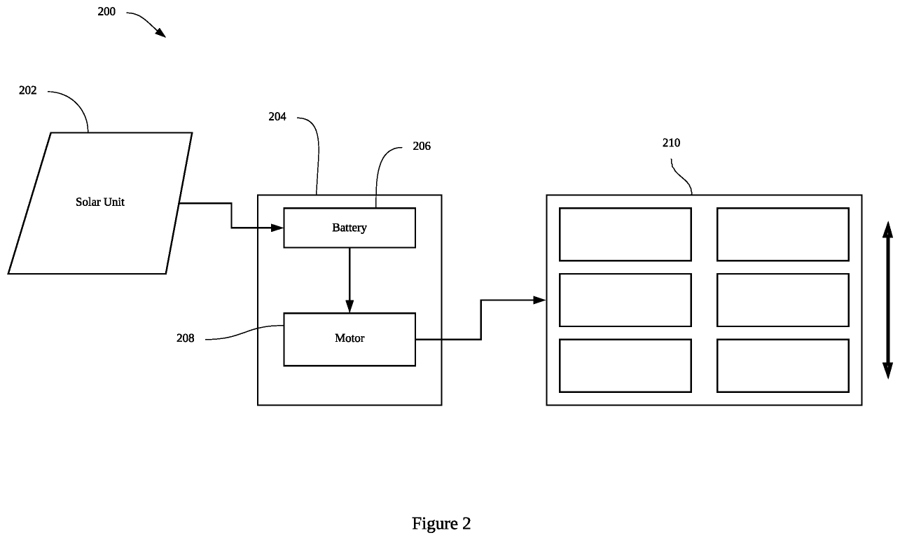

FIG. 2 is a schematic illustration of a system 200 for using a solar unit to power an overhead door operator according to embodiments of the present disclosure. The system 200 includes a solar unit 202 that converts solar energy to electrical power. The system 200 also includes an overhead door operator 204 that has a battery 206 and a motor 208. The battery 206 is a modern battery such as a lithium-ion battery capable of long-term sustained use. In contrast to conventional lead acid batteries, the lithium-ion batteries can sustain long-term use without deterioration. The battery 206 provides power to the motor 208 which operates the door 210 to raise, lower, stop, and otherwise control the overhead door 210. The operator 204 can also provide power to accessories such as sensors and lights etc. The system 200 is a closed system, where the battery 206 receives its power from the solar unit 202 and from no other source, and wherein the motor 208 receives uses the power from the battery 206 to operate the overhead door. In contrast to conventional systems that use batteries for backup, the present system 200 uses the batteries to store power from the solar unit and use the power to operate the overhead door 210.

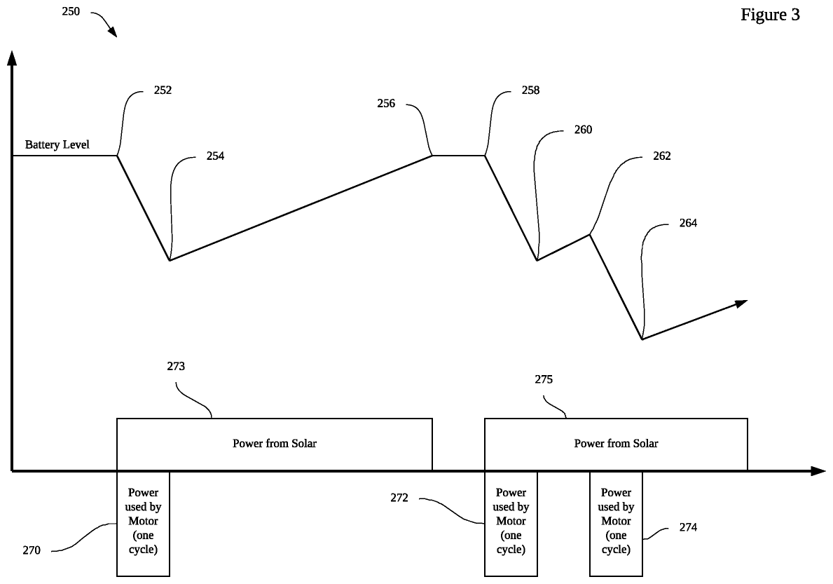

FIG. 3 is a graph 250 showing battery level over time according to embodiments of the present disclosure. The battery level begins at a fully charged level and is depleted by the motor executing a cycle of the overhead door. The battery level is replenished over time by the solar unit. At 252 the first cycle is initiated. Before this time the battery is at a theoretical peak and is receiving no replenishment from the solar unit. At 252 the power used by the motor at 270 is a drain on the battery. At the same time the solar unit initiates a replenishment at 273. At 254 the cycle is completed and the drain on the battery ceases. However, the battery has not been replenished because the rate of depletion is greater than the rate of replenishment. The overhead door opener is an intermittent duty system that for most of its life sits idle. The time spent executing a cycle is a small fraction of the total time. Accordingly, the solar unit can be sized to provide enough power to replenish the battery over a relatively long time compared to the length of time of a cycle. Solar power continues to come into the system until 256 at which point the battery is replenished and the solar input can be ceased or diverted elsewhere. At 258 another cycle is initiated, and the battery is depleted at 272. Power is replenished into the battery at 275. At 260 the cycle ends and the battery charges until 262 at which time another cycle begins at 274. This cycle begins before the battery has fully replenished. At 264 the cycle ends, and the battery continues to be replenished. Note that the power from the solar unit can continue during the cycle and between cycles equally.

The power cycle continues in this way. If many cycles are executed without allowing the battery to replenish such that the battery level reaches zero, the system can deliver an error and enter a slow-down state in which the battery charges from the solar unit and a message to can be delivered to apprise the user. The downtime will last until there is sufficient power to execute at least one cycle. The user may be advised that the system has entered a slow-down state and that upon reopening cycles may be limited to one or two separated by a predefined time period during which the battery will charge and the system can slow down. The system can be constructed such that the size of the solar unit determines the rate of replenishment. If the number of expected cycles is known, the solar unit can be constructed accordingly. In most cases, there will be fewer than 25 cycles per day during normal, residential use. A residential system can therefore have a solar unit and battery capable of delivering up to 25 cycles per day without depleting the battery and entering the slow-down state. In some embodiments the depletion rate of the motor on the battery is at least three times the replenishment rate of the solar unit to the battery.

In some embodiments, the system includes a processor that tracks the amount of power consumed by the door opener over a certain period of time and a memory that can store information pertaining to rates of replenishment, drain, usage, and other items.

Particularly because environmental factors can effect the amount of power generated by a solar panel, the processor preferably also tracks the amount of power replenished by that particular solar panel in that location. Reference is made to US Published Patent Application No. 2020-0169092, entitled “Solar Power System with Individualized Energy Prediction,” the entire disclosure of which is incorporated by reference.

In these embodiments, the processor can send a report to the user of the door opener, to indicate the “health” of the system. Where a single solar panel is not providing enough power to reliably replenish the battery, the report may recommend addition of another solar panel in the same system. In these embodiments, the hardware that mounts the first solar panel is configured to mount a second solar panel if desired. Also, the electrical connections for the solar panel, is also configured to connect a second solar panel if desired.

In some embodiments the solar panel operates according to solar power available through sunlight, in which case the amount of power that can be produced cannot be easily increased. In other embodiments the solar panel can be directed to divert more or less energy toward the battery for the overhead door as needed. The need for such a change can be calculated by the processor and memory using information in the memory. For example, if the solar unit is set at a first level and over a certain time period of normal use, the battery demonstrates a steady downward trajectory it may suggest that more power from the solar unit to the battery would improve the trajectory. In some cases, the solar unit may be responsible for providing power to more than just the motor, and it is possible that more power is available and can be directed to the battery between cycles. The processor and memory can execute this change. In some embodiments the system can set as an objective to have a flat trajectory for the battery level. In other embodiments the objective can be to have a slightly upward trajectory, such that over time the battery will reach a “full” status.

In still other embodiments, the amount of power available from the solar unit can be varied by increasing or decreasing the amount of radiant energy hitting the solar panel, such as by changing the angle of the panel with respect to the sun or by covering or uncovering portions of the panel.

In still yet other embodiments, the user may get a message from the controller that the amount of power available from the solar unit is not enough for smooth operation. As such, the user may be given the option of adding an additional solar panel to the system, which preferably has been designed as modular to be amenable to such an addition.

The invention has been described with reference to various specific and preferred embodiments and techniques. Nevertheless, it is understood that many variations and modifications may be made while remaining within the spirit and scope of the invention.

What is claimed is:

1. A system for operating a door opener, comprising:
a motor configured to raise and lower the door, wherein a cycle is one raise and one lower of the door;
a battery configured to provide power to the motor; and
a solar unit configured to convert solar energy into electrical power to charge the battery;
wherein the motor depletes the battery during operation at an operation rate;
wherein the solar unit charges the battery at a replenishment rate that is less than one third of the operation rate; and
wherein the replenishment rate is sufficient to keep the battery charged at a level sufficient to power the motor for at least 12 cycles in a 24-hour period.

2. The system of claim 1, wherein the replenishment rate is sufficient to keep the battery charged at a level sufficient to power the motor for at least 25 cycles in a 24-hour period.

3. The system of claim 1, further comprising a processor and memory configured to execute computer-readable instructions that, when executed by the processor cause the system to perform acts, the acts including:
monitoring the battery; and
if a battery level exhibits a downward trajectory for more than a predetermined time, instructing the solar unit to increase the replenishment rate.

4. The system of claim 3, the acts further comprising monitoring a load on the motor, and if the load is greater than a predetermined threshold, instructing the solar unit to increase the replenishment rate.

5. The system of claim 1, further comprising a processor and memory configured to execute computer-readable instructions that, when executed by the processor cause the system to perform acts, the acts including issuing a warning if the replenishment rate is insufficient to keep the battery charged at a level sufficient to power the motor for at least 12 cycles in a 24-hour period.

6. The system of claim 1 wherein the solar unit comprises a solar panel on a roof of a structure connected to the door.

7. The system of claim 1 wherein the solar unit and door operator form a closed loop, wherein the solar unit provides power to the door operator and to no other device.

8. A power system for a door, the power system comprising:
a battery powering the door;
a solar unit configured to charge the battery;
a processor and memory configured to execute computer readable instructions that, when executed by the processor cause the power system to perform acts, the acts comprising:
monitoring an operation depletion rate of the battery during operation of the door;
monitoring an operation time of the door corresponding to the operation depletion rate;
monitoring a replenishment rate of the battery from the solar unit; and
if a multiple of the operation depletion rate and the operation time are greater than a predetermined threshold, increasing the replenishment rate.

9. The power system of claim 7, the acts further comprising, if the multiple of the operation depletion rate and the operation time are less than a predetermined threshold, decreasing the replenishment rate.

10. The power system of claim 7 wherein the operation time comprises 25 cycles in a 24-hour period, wherein a cycle comprises one raising of the door and one lowering of the door.

11. The power system of claim 7 wherein the replenishment rate is less than one third of the operation depletion rate.

12. The power system of claim 7, the acts further comprising comparing the operation time to a predetermined threshold and if the operation time exceeds the predetermined threshold, entering a temporary slow-down state in which the door can be operated only at a predetermined interval of approximately one cycle per hour, wherein a cycle comprises one full raise of the door and one full lowering of the door.

13. An automated door, comprising:
a motor to operate the door to raise, lower, and stop movement of the door;
a battery powering the motor; and
a solar unit having a capacity to charge the battery at a replenishment rate;
wherein the battery has an operation depletion rate correlated to operation of the motor through cycles, wherein one cycle comprises one raise of the door and one lower of the door;
wherein the capacity of the solar unit is sufficient to maintain the battery at an average stable level unless the motor executes more than 25 cycles in a 24-hour period; and
wherein the operation depletion rate is at least three times greater than the replenishment rate.

14. The automated door of claim 13 wherein the solar unit provides power to the battery and no other power source is provided to the door.

15. The automated door of claim 13 wherein the operation depletion rate is at least 10 times greater than the replenishment rate.

16. The automated door of claim 13 wherein if the motor executes more than 25 cycles in a 24-hour period the motor enters a slow-down state in in which the motor is limited to one cycle per hour.

17. The automated door of claim 13 wherein the fixed capacity of the solar unit is an arbitraty limit imposed on the solar unit, and wherein if the motor executes more than 25 cycles in a 24-hour period the solar unit is configured to increase the fixed capacity to a second capacity level.

18. The automated door of claim 17 wherein the solar unit is configured to return to the fixed capacity when the battery reaches a full charge.

19. The automated door of claim 13 wherein the solar unit is sufficient to maintain the battery at an increasing level, such that a sum of the operation depletion rate and the idle depletion rate is equal to or less than the replenishment rate when averaged over a 24-hour period.

20. The automated door of claim 13 wherein the replenishment rate is greater than a sum of the operation depletion rate and the idle depletion rate by at least one percent.
